(19) United States
(12) Patent Application Publication
(10) Pub. No.: US 2014/0307354 A1
(43) Pub. Date: Oct. 16, 2014

(54) ESD PROTECTION CIRCUIT

(71) Applicant: KABUSHIKI KAISHA TOSHIBA, Tokyo (JP)

(72) Inventor: Kentaro WATANABE, Kanagawa (JP)

(73) Assignee: KABUSHIKI KAISHA TOSHIBA, Tokyo (JP)

(21) Appl. No.: 14/173,342

(22) Filed: Feb. 5, 2014

(30) Foreign Application Priority Data
Apr. 16, 2013 (JP) 2013-085678

(51) Int. Cl. H02H 9/04

(52) U.S. Cl. CPC H02H 9/041
USPC 361/56

(57) ABSTRACT

An ESD protection circuit includes an RC circuit connected between a first power terminal to which an external power voltage is to be applied, a second power terminal to which a ground potential is to be applied, and an internal power supply line connected to a third power terminal. A switch transistor having a main current channel is connected between the first power terminal and the internal power supply line, and a shunt transistor having a main current channel is connected between the second power terminal and the internal power supply line. A trigger signal that is based on an output of the RC circuit is supplied to a control electrode of the shunt transistor through a drive circuit.

### CROSS-REFERENCE TO RELATED APPLICATION

This application is based upon and claims the benefit of priority from Japanese Patent Application No. 2013-085678, filed Apr. 16, 2013, the entire contents of which are incorporated herein by reference.

### FIELD

Embodiments described here relate generally to an ESD protection circuit in a semiconductor device, and particularly to an ESD protection circuit in the semiconductor device that includes an internal power supply line for biasing an internal load circuit.

### BACKGROUND

Hitherto, various kinds of protection circuits against Electrostatic Discharge (ESD) have been proposed. ESD means a discharge from an electrostatically charged person or machine to a semiconductor device and a discharge from an electrostatically charged semiconductor device to a ground potential. When ESD occurs in a semiconductor device, a large amount of electric charge flows through the semiconductor device as a current, and the electric charge generates a high voltage within the semiconductor device, to potentially cause a dielectric breakdown of an internal element and a failure of the semiconductor device.

As a protection circuit against ESD (hereinafter, ESD protection circuit), a protection element called RCT (RC Triggered) MOS transistor including a shunt MOS transistor driven by an RC circuit has been used. The RC circuit is designed to respond to sharp power rises. However, there may be times when the shunt MOS transistor turns on due to sharp power rises even though there is no ESD that results in a so-called rush current (e.g., during power on). In a semiconductor device including an internal power supply line, when power that has risen sharply is supplied to the internal power supply line through a switch transistor, the RC circuit connected between the internal power supply line and the ground terminal responds and the shunt MOS transistor may be turned on by a trigger signal from the RC circuit even though there is no ESD that generates a rush current. Therefore, a technique for forcibly turning off the shunt MOS transistor by using a control signal upon power on has been employed. Further, when a power terminal for monitoring a power voltage, or a power terminal for directly supplying an external power voltage is connected to the internal power supply line, the power terminal is exposed to the outside of the semiconductor device and therefore, an ESD protection circuit is required to handle an ESD surge applied to the power terminal.

### BRIEF DESCRIPTION OF THE DRAWINGS

FIG. 1 is a circuit diagram depicting a first embodiment.

FIG. 2 is a circuit diagram depicting a second embodiment.

FIG. 3 is a view schematically illustrating a cross-section of a PMOS transistor and an NMOS transistor for use in a switch transistor and a shunt transistor.

### DETAILED DESCRIPTION

Embodiments provide an ESD protection circuit, in a semiconductor device including an internal power supply line, which can avoid unintended activation of a shunt transistor connected to the internal power supply line, without supplying any particular control signal, when a predetermined power voltage is supplied to the internal power supply line through a switch transistor, and which can protect against various kinds of ESD current surges.

According to one embodiment, an ESD protection circuit includes a first power terminal to which an external power voltage is to be applied, a second power terminal to which a ground potential is to be applied, an internal power supply line, an RC circuit including a resistor and a capacitor connected in series between the first and the second power terminals, a common node to which the resistor and the capacitor are connected, a switch transistor having a main current channel connected between the first power terminal and the internal power supply line, a shunt transistor having a main current channel connected between the second power terminal and the internal power supply line, and a drive circuit which supplies a trigger signal to a control electrode of the shunt transistor in accordance with a potential of the common node.

Hereinafter, the ESD protection circuit according to the embodiments will be described in detail with reference to the drawings. The embodiments are not intended to limit the disclosure.

### First Embodiment

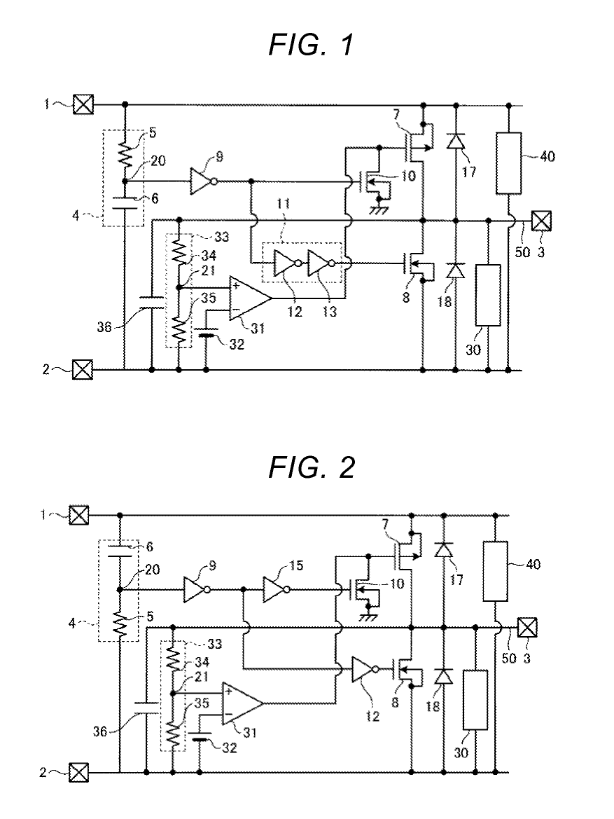

FIG. 1 is a circuit diagram depicting the structure of the ESD protection circuit according to a first embodiment. The embodiment shows an example application to a semiconductor device including a voltage regulator which converts an external power voltage into a predetermined voltage and supplies the voltage to the internal power supply line. The ESD circuit includes a first power terminal 1 to which an external power voltage is applied and a second power terminal 2 to which the ground potential is supplied. A third power terminal 3 is connected to an internal power supply line 50. The third power terminal 3 is used as a terminal for monitoring a voltage of, for example, a voltage regulator. An RC circuit 4 formed by a series circuit including a resistor 5 and a capacitor 6 is connected between the first power terminal 1 and the second power terminal 2. The resistor 5 and the capacitor 6 are connected by a common node 20. The source electrode and the back gate electrode of a switch transistor (hereinafter, referred to as PMOS switch transistor) 7 formed by a PMOS transistor are connected to the first power terminal 1, and the drain electrode of the PMOS switch transistor 7 is connected to the third power terminal 3 through the internal power supply line 50. According to this, the source and drain current channel that is the main current channel of the PMOS switch transistor 7 is connected between the first power terminal 1 and the third power terminal 3. The drain electrode of an NMOS transistor 10 is connected to the gate electrode of the PMOS switch transistor 7. The source electrode and the back gate electrode of the NMOS transistor 10 are grounded.

The drain electrode of a shunt transistor (hereinafter, referred as NMOS shunt transistor) 8 formed by the NMOS transistor is connected to the third power terminal 3, and the source electrode and the back gate electrode of the NMOS shunt transistor 8 are connected to the second power terminal 2. According to this, the source and drain current channel that is the main current channel of the NMOS shunt transistor 8 is connected between the second power terminal 2 and the third power terminal 3.

The common node 20 that is a joint portion of the resistor 5 and the capacitor 6 forming the RC circuit 4 is connected to the input terminal of an inverter 9, for example, formed by CMOS. The output of the inverter 9 is supplied to the gate electrode of the NMOS transistor 10. The output of the inverter 9 is further supplied to the gate electrode of the NMOS shunt transistor 8 through a buffer circuit 11 including two stages of inverters 12 and 13. The inverters 12 and 13 are also formed by, for example, CMOS. The structure of the inverter 9 and the NMOS transistor 10 forms a first drive circuit in which a trigger signal in response to the output signal of the RC circuit 4 is supplied to the gate electrode that is a control electrode of the PMOS switch transistor 7. Similarly, the structure including the inverter 9 and the buffer circuit 11 forms a second drive circuit in which a trigger signal in response to the output signal of the RC circuit 4 is supplied to the gate electrode that is a control electrode of the NMOS shunt transistor 8. By using at least one stage of inverter, for example, the inverter 9 of the first and second drive circuits, the output signal of the RC circuit 4 can be waveform-shaped into binary signal having a High level and a Low level and supplied to the gate electrodes of the NMOS shunt transistor 8 and the NMOS transistor 10.

The output of a differential amplifier 31 is supplied to the gate electrode of the PMOS switch transistor 7. The potential of the common node 21 that is a joint portion of a resistor 34 and a resistor 35 forming a partial pressure circuit 33 is supplied to a non-inverting input terminal (+) of the differential amplifier 31, while a reference voltage 32 is supplied to an inverting input terminal (−) thereof. According to a comparison operation between the potential of the common node 21 or the feedback voltage of the internal power supply line 50 and the reference voltage 32 by the differential amplifier 31, the PMOS switch transistor 7 is controlled to perform a voltage regulation so that the potential of the common node 21 may be equal to the reference voltage 32. A capacitor 36 connected between the internal power supply line 50 and the second power terminal 2 functions as a smoothing capacitor.

A cathode electrode of a first ESD protection diode 17 is connected to the first power terminal 1 and the anode electrode thereof is connected to the third power terminal 3. A cathode electrode of a second ESD protection diode 18 is connected to the third power terminal 3 and the anode electrode thereof is connected to the second power terminal 2. An internal load circuit 40 biased by the voltage of the first power terminal 1 is connected between the first power terminal 1 and the second power terminal 2, and an internal load circuit 30 biased by the voltage of the internal power supply line 50 is connected between the third power terminal 3 and the second power terminal 2.

Next, a circuit operation according to the embodiment will be described. In the normal state in which a predetermined external power voltage is applied to the first power terminal 1 and the second power terminal 2 is grounded, the potential of the common node 20 of the RC circuit 4, namely, the output signal of the RC circuit 4 is at a High level. Accordingly, a signal of a Low level is supplied to the gate electrode of the NMOS shunt transistor 8 through three stages of inverter circuits 9 to 13. Therefore, in the normal state, the NMOS shunt transistor 8 is turned off.

Since the signal of a Low level that is the output of the inverter 9 is supplied to the gate electrode of the NMOS transistor 10, the NMOS transistor 10 is turned off in the normal state. Therefore, the PMOS switch transistor 7 is turned on and off according to the output of the differential amplifier 31 supplied to the gate electrode of the above transistor 7, namely, the output of the differential amplifier 31 based on a comparison result between the reference voltage 32 and the potential of the common node 21 of the partial pressure circuit 33. Even if the PMOS switch transistor 7 is turned on and the sharply rising power voltage supplied to the first power terminal 1 is supplied to the internal power supply line 50, generation of rush current can be avoided because the NMOS shunt transistor 8 is turned off.

Next, the ESD protection operation will be described. Since it is difficult to predict which power terminal an ESD surge is applied to, the above operation will be described in every combination of the power terminals. As a first mode, a description will be made when a positive ESD surge is applied to the first power terminal 1 and the second power terminal 2 is the ground potential. In the first mode, the RC circuit 4 responds to the ESD surge and a through current flows into the second power terminal 2 through the RC circuit 4. Due to a voltage drop in the resistor 5 of the RC circuit 4 by the through current, when the potential of the common node 20 gets lower than the threshold of the inverter 9, the output of the inverter 9 goes to a High level. By the High level signal being applied to the gate electrode of the NMOS transistor 10, the NMOS transistor 10 is turned on. When the NMOS transistor 10 is turned on, a trigger signal of a Low level is supplied to the gate electrode of the PMOS switch transistor 7, hence to turn on the PMOS switch transistor 7.

On the other hand, the output of a High level of the inverter 9 is supplied to the buffer circuit 11 and a trigger signal of a High level is applied from the rear inverter 13 of the two stages of inverters 12 and 13 to the gate electrode of the NMOS shunt transistor 8. According to this, the NMOS shunt transistor 8 is turned on. Therefore, an ESD discharge channel is formed by the PMOS switch transistor 7 and the NMOS shunt transistor 8 between the first power terminal 1 and the second power terminal 2. Namely, the PMOS switch transistor 7 works also as the ESD discharge element.

Next, a description will be made when a positive ESD surge is applied to the first power terminal 1 and the third power terminal 3 is the ground potential. In the second mode, a through current caused by application of the positive ESD surge flows into the third power terminal 3 through the RC circuit 4 and the second ESD protection diode 18. Due to a voltage drop in the resistor 5 of the RC circuit 4 by the through current, when the potential of the common node 20 gets lower than the threshold of the inverter 9, the output of the inverter 9 goes to a High level. By the High level signal being applied to the gate electrode of the NMOS transistor 10, the NMOS transistor 10 is turned on. When the NMOS transistor 10 is turned on, a trigger signal of a Low level is supplied to the gate electrode of the PMOS switch transistor 7, to turn on the PMOS switch transistor 7. By turning on the PMOS switch transistor 7, an ESD discharge channel is formed by the PMOS switch transistor 7 between the first power terminal 1 and the third power terminal 3.

Next, a description will be made when a positive ESD surge is applied to the third power terminal 3 and the first power terminal 1 is the ground potential. In the third mode, the first ESD protection diode 17 is forward biased and turned on, hence to form an ESD discharge channel.

Next, a description will be made when a positive ESD surge is applied to the third power terminal 3 and the second power terminal 2 is the ground potential. In the fourth mode, a through current caused by application of the positive ESD surge flows into the second power terminal 2 through the first ESD protection diode 17 and the RC circuit 4. Due to a voltage drop in the resistor 5 of the RC circuit 4 by the through current, when the potential of the common node 20 gets lower than the threshold of the inverter 9, the output of the inverter 9 goes to a High level. The signal of a High level of the inverter 9 is applied to the gate electrode of the NMOS shunt transistor 8 through the buffer circuit 11 including the two stages of the inverters 12 and 13. According to this, the NMOS shunt transistor 8 is turned on and an ESD discharge channel is formed by the NMOS shunt transistor 8 between the second power terminal 2 and the third power terminal 3.

Next, a description will be made when a positive ESD surge is applied to the second power terminal 2 and the first power terminal 1 is the ground potential. In the fifth mode, the first ESD protection diode 17 and the second ESD protection diode 18 are both forward biased and turned on. According to this, an ESD discharge channel is formed by the first ESD protection diode 17 and the second ESD protection diode 18 between the first power terminal 1 and the second power terminal 2.

Next, a description will be made when a positive ESD surge is applied to the second power terminal 2 and the third power terminal 3 is the ground potential. In the sixth mode, the second ESD protection diode 18 is forward biased and turned on, hence to form an ESD discharge channel. As mentioned above, according to the embodiment, an ESD discharge channel is formed among the first to the third power terminals according to each of the possible ESD surge application modes. According to this, the internal load circuits 30 and 40 formed within the semiconductor device can be protected from the breakdown by the ESD.

The ESD protection operation is performed also in the case of applying a negative ESD surge to each power terminal. The operation when a negative ESD surge is applied to the first power terminal 1 and the second power terminal 2 is the ground potential corresponds to that in the above-mentioned fifth mode, and an ESD discharge channel is formed by the first ESD protection diode 17 and the second ESD protection diode 18. The operation when a negative ESD surge is applied to the first power terminal 1 and the third power terminal 3 is the ground potential corresponds to that in the above-mentioned third mode and an ESD discharge channel is formed by the first ESD protection diode 17.

The operation when a negative ESD surge is applied to the third power terminal 3 and the first power terminal 1 is the ground potential corresponds to that in the above-mentioned second mode, and an ESD discharge channel is formed by the PMOS switch transistor 7. The operation when a negative ESD surge is applied to the third power terminal 3 and the second power terminal 2 is the ground potential corresponds to that in the above-mentioned sixth mode, and an ESD discharge channel is formed by the second ESD protection diode 18.

The operation when a negative ESD surge is applied to the second power terminal 2 and the first power terminal 1 is the ground potential corresponds to that in the above mentioned first mode, and an ESD discharge channel is formed by the PMOS switch transistor 7 and the NMOS shunt transistor 8. The operation when a negative ESD surge is applied to the second power terminal 2 and the third power terminal 3 is the ground potential corresponds to that in the above-mentioned fourth mode, and an ESD discharge channel is formed by the NMOS shunt transistor 8. As mentioned above, according to the embodiment, the internal load circuits 30 and 40 formed within the semiconductor device can be also protected from a negative ESD surge on the first to the third power terminals.

According to the first embodiment, conductivity of the NMOS shunt transistor 8 connected between the third power terminal 3 and the second power terminal 2 connected to the internal power supply line 50 is controlled according to the trigger signal corresponding to the output signal of the RC circuit 4 connected between the first power terminal 1 and the second power terminal 2. According to the structure, even if the external power voltage that increases sharply is applied to the internal power supply line 50 through the PMOS switch transistor 7, it is possible to avoid turning on the NMOS shunt transistor 8 and a rush current.

Further, the ESD protection operation is performed in response to the positive and negative ESD surge applied to each of the power terminals 1 to 3, and the internal load circuit formed within the semiconductor device can be protected from the ESD surge. Further, when the ESD surge is applied to the first power terminal 1, the PMOS switch transistor 7 is turned on, to discharge the ESD surge. Therefore, a situation in which currents concentrate on a specified element region of the PMOS switch transistor 7 hardly occurs and a risk of breakdown is reduced. According to the embodiment, the output signal of one RC circuit 4 connected between the first power terminal 1 and the second power terminal 2 can control the conductivity of both the NMOS shunt transistor 8 and the PMOS switch transistor 7 that also functions as the ESD discharge element.

Even if the third power terminal 3 is not exposed to the outside as the external terminal of the semiconductor device, when a positive ESD surge is applied to the first power terminal 1, there is a possibility that a high voltage may be supplied to the internal power supply line 50 through the PMOS switch transistor 7. Also in this case, as mentioned above, since the ESD protection operation is performed in the ESD surge application mode between the first power terminal 1 and the second power terminal 2, the internal load circuit 30 connected between the internal power supply line 50 and the second power terminal 2 can be protected from the breakdown caused by the ESD surge. Here, the internal power supply line 50 is indicated by a line of wiring on the circuit diagram; however, on the semiconductor device, it is formed by, for example, a patterned metal wiring.

### Second Embodiment

FIG. 2 is a circuit diagram depicting a second embodiment. The same reference numerals are given to the same component elements in the first embodiment and the description thereof is omitted. This embodiment is different from the first embodiment in the structure of the RC circuit 4 connected between the first power terminal 1 and the second power terminal 2. Namely, the capacitor 6 is connected on the side of the first power terminal 1 and the resistor 5 is connected on the side of the second power terminal 2. The common node 20 that is the joint portion of the capacitor 6 and the resistor 5 is connected to the input terminal of the inverter 9. The output terminal of the inverter 9 is connected to the input terminal of the inverter 15, and the output of the inverter 15 is supplied to the gate electrode of the NMOS transistor 10. The output of the inverter 9 is connected to the input terminal of the inverter 12, and the output of the inverter 12 is supplied to the gate electrode of the NMOS shunt transistor 8. The inverters 9 and 15 and the NMOS transistor 10 form a first drive circuit from which a trigger signal corresponding to the output signal of the RC circuit 4 is supplied to the gate electrode of the PMOS switch transistor 7, and the inverters 9 and 12 form a second drive circuit from which a trigger signal corresponding to the output signal of the RC circuit 4 is supplied to the gate electrode of the NMOS shunt transistor 8.

According to the embodiment, the potential of the common node 20 of the RC circuit 4 is inverted from in the case of the first embodiment. Namely, in the normal state in which a predetermined external power voltage is applied to the first power terminal 1 and the second power terminal is grounded, the potential of the common node 20 of the RC circuit 4 is a Low level. The output of the inverter 9 is supplied to the gate electrode of the NMOS shunt transistor 8 through one stage of the inverter 12. Since the output of the inverter 9 is inverted by the inverter 12 and supplied to the gate electrode of the NMOS shunt transistor 8, the signal of a Low level is supplied to the gate electrode of the NMOS shunt transistor 8 in the normal state, hence to turn off the NMOS shunt transistor 8. On the other hand, the output of the inverter 9 is supplied to the gate electrode of the NMOS transistor 10 through the inverter 15. In the normal state, since the signal of a Low level is supplied to the gate electrode of the NMOS transistor 10, the NMOS transistor 10 is turned off. Therefore, in the normal state, conductivity of the PMOS switch transistor 7 is controlled according to the signal from the differential amplifier 31. Even if the PMOS switch transistor 7 is turned on and a power voltage supplied to the first power terminal that increases sharply is supplied to the internal power supply line 50, the NMOS shunt transistor 8 is turned off, hence to avoid the generation of rush current.

The ESD protection operation when a positive ESD surge is applied to the first power terminal 1 and the second power terminal 2 is the ground potential is as follows. This mode corresponds to the first mode in the first embodiment. According to the ESD surge applied to the first power terminal 1, a through current flows into the second power terminal 2 through the RC circuit 4. When the potential of the common node 20 gets higher than the threshold of the inverter 9 according to a voltage drop in the resistor 5 of the RC circuit 4 by the through current, the output of the inverter 9 goes to a Low level. When the output of the inverter 9 goes to a Low level, the output of the inverter 15 becomes a High level, and the trigger signal of a High level is supplied to the gate electrode of the NMOS transistor 10, hence to turn on the NMOS transistor 10. According to this, the trigger signal of the Low level is supplied to the gate electrode of the PMOS switch transistor 7, hence to turn off the PMOS switch transistor 7.

On the other hand, the output of the inverter 9 is inverted by the inverter 12 and supplied to the gate electrode of the NMOS shunt transistor 8. Namely, the signal of a High level is supplied to the gate electrode of the NMOS shunt transistor 8, hence to turn on the NMOS shunt transistor 8. An ESD discharge channel is formed between the first power terminal 1 and the second power terminal 2, by turning on the PMOS switch transistor 7 and the NMOS shunt transistor 8 of which the main current channel is connected between the first power terminal 1 and the second power terminal 2. The second to the sixth modes and the ESD protection operation for the negative ESD surge applied to each power terminal in the second embodiment are the same also as those in the first embodiment; therefore, the description thereof is omitted.

According to the second embodiment, one end of the capacitor 6 forming the RC circuit 4 is connected to the first power terminal 1 and one end of the resistor 5 is connected to the second power terminal 2. According to the different connection relation of the resistor 5 and the capacitor 6, the structure of the drive circuit for supplying the trigger signal depending on the output signal of the RC circuit 4 to the gate electrodes of the PMOS switch transistor 7 and the NMOS shunt transistor 8 is different from that in the first embodiment. By adjusting and changing the number of the inverters forming the drive circuit, it is possible to provide an ESD protection circuit capable of avoiding turning on the NMOS shunt transistor 8 and protecting the internal load circuit from the breakdown by the ESD surge applied to each power terminal, similarly to the first embodiment. Similarly to the first embodiment, one RC circuit 4 connected between the first power terminal 1 and the second power terminal 2 can control the conductivity of both the PMOS switch transistor 7 working also as the ESD discharge element and the NMOS shunt transistor 8.

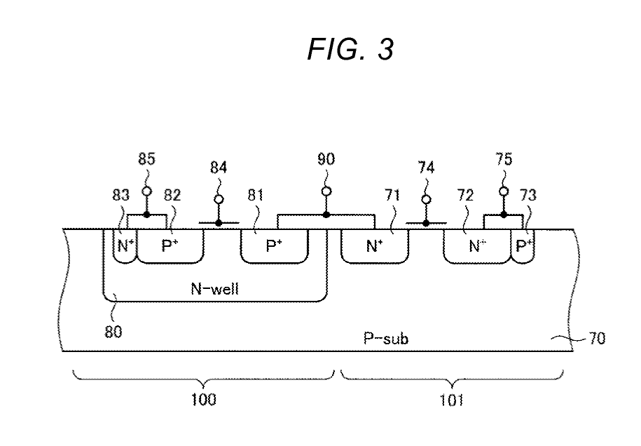

FIG. 3 is a view schematically showing the cross-section of the PMOS transistor and the NMOS transistor used for the switch transistor and the shunt transistor. The first ESD protection diode 17 and the second ESD protection diode 18 described in the above mentioned embodiment may be respectively formed by the parasitic diodes of the PMOS switch transistor 7 and the NMOS shunt transistor 8. A region 100 indicates a region for forming the PMOS switch transistor 7 and a region 101 indicates a region for forming the NMOS shunt transistor 8. An diffusion area 71 that becomes the drain region of the NMOS shunt transistor 8 and an N⁺ diffusion area 72 that becomes the source region thereof are formed in a P type substrate 70. A P+ diffusion area 73 that becomes a back gate contact region is formed in adjacent to the N⁺ diffusion area 72. The back gate of the NMOS shunt transistor 8 is formed in the P type substrate between the N⁺ diffusion areas 72 and 71 that are respectively the source region and the drain region. The N⁺ diffusion area 72 and the P⁺ diffusion area 73 are connected to a terminal 75 in common. The terminal 75 corresponds to the source electrode of the NMOS shunt transistor 8. By connecting the N+ diffusion area 72 that becomes the source region and the P⁺ diffusion area 73 that becomes the back gate contact region in common, a parasitic diode is formed with the P type substrate 70 defined as the anode and the N⁺ diffusion area 71 that is the drain region defined as the cathode. This parasitic diode may be used as the second ESD protection diode 18. The terminal 74 on the channel region corresponds to the gate electrode of the NMOS shunt transistor 8.

An N type well region 80 is formed in the P type substrate 70. The P⁺ diffusion area 82 that is the source region of the PMOS switch transistor 7 and the P⁺ diffusion area 81 that is the drain region are formed within the N type well region 80. The N⁺ diffusion area 83 that is the back gate contact region is formed adjacently to the P⁺ diffusion area 82. The back gate of the PMOS switch transistor 7 is formed in the N type well region 80 between the P⁺ diffusion areas 82 and 81 that become the source region and the drain region. The P⁺ diffusion area 82 and the N⁺ diffusion area 83 are connected to a terminal 85 in common. The terminal 85 becomes the source electrode of the PMOS switch transistor 7. By connecting the P⁺ diffusion area 82 and the N⁺ diffusion area 83 that becomes the back gate contact region in common, a parasitic diode is formed with the N type well region 80 defined as the cathode and the P⁺ diffusion area 81 defined as the anode. This parasitic diode may be used as the first ESD protection diode 17. The terminal 84 on the channel region corresponds to the gate electrode of the PMOS switch transistor 7. The N⁺ diffusion area 71 and the P⁺ diffusion area 81 are connected in common to the terminal 90 that is the drain electrode.

The first and the second embodiments have been described in the case of using the PMOS switch transistor 7 as a switch transistor of the voltage regulator. The disclosure is not restricted to this but can be applied to the structure of turning on and off the PMOS switch transistor 7, according to a control signal applied to the gate electrode of the PMOS switch transistor 7 and supplying the external power voltage supplied to the first power terminal 1 to the internal power supply line 50 as it is when the PMOS switch transistor 7 is turned on. In the above structure, when it is not necessary to operate the internal load circuit 30, the PMOS switch transistor 7 is turned off, to stop a voltage supply to the internal load circuit 30, hence to save the power consumption. In this structure, even when the PMOS switch transistor 7 is turned on and the external power voltage supplied to the first power terminal 1 that increases sharply is supplied to the internal power supply line 50, the RC circuit 4 is not connected to the internal power supply line 50 and therefore, a trigger signal is not supplied to the NMOS shunt transistor 8 by mistake, which can avoid turning on of the NMOS shunt transistor 8 and the generation of rush current. Further, it may be formed such that another external power voltage than the external power voltage supplied to the first power terminal 1 can be directly supplied to the third power terminal 3 exposed to the outside of the semiconductor. For example, the above structure satisfies both cases where the external power voltage supplied to the first power terminal 1 is supplied to the internal power supply line 50 through the PMOS switch transistor 7 and where the external power voltage supplied to the third power terminal 3 is supplied to the internal power supply line 50 as it is. Also in this structure, as mentioned above, the internal load circuit can be protected from the ESD surge applied to the third power terminal 3 exposed to the outside of the semiconductor device.

Although the embodiments using the NMOS transistor as the shunt transistor have been described, the PMOS transistor can be used as the shunt transistor. In this case, the number of stages of the inverters in the drive circuit of supplying a trigger signal from the RC circuit 4 to the gate electrode of the PMOS shunt transistor is increased or decreased by one. Further, a bipolar transistor can be used as the shunt transistor or as the switch transistor. In this case, the emitter and collector current channel of the bipolar transistor forms a main current channel and the bias relation in the case of using the NPN transistor corresponds to that in the case of using the NMOS transistor.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. An ESD protection circuit comprising:
a first power terminal to which an external power voltage is to be applied;
a second power terminal to which a ground potential is to be applied;
an internal power supply line;
an RC circuit including a resistor and a capacitor connected in series between the first power terminal and the second power terminal;
a common node to which the resistor and the capacitor are connected; and
a switch transistor having a main current channel connected between the first power terminal and the internal power supply line;
a shunt transistor having a main current channel connected between the second power terminal and the internal power supply line;
a drive circuit which supplies a trigger signal to a control electrode of the shunt transistor in accordance with a potential of the common node.

2. The circuit according to claim 1, wherein
the internal power supply line is connected to a third power terminal.

3. The circuit according to claim 1, wherein
a signal based on a comparison result between a feedback voltage of the internal power supply line and a predetermined reference voltage is supplied to the control electrode of the switch transistor.

4. The circuit according to claim 1, wherein
the shunt transistor is an NMOS transistor having source and back gate electrodes that are connected to the second power terminal, a drain electrode connected to the internal power supply line, and a gate electrode which a trigger signal of the first drive circuit is supplied to.

5. The circuit according to claim 1, wherein
the switch transistor is a PMOS transistor having source and back gate electrodes connected to the first power terminal, and a drain electrode connected to the internal power supply line.

6. The circuit according to claim 1, wherein
the drive circuit includes at least one stage of an inverter circuit.

7. The circuit according to claim 1, further comprising:
a first ESD protection diode connected between the first power terminal and the internal power supply line; and
a second ESD protection diode connected between the second power terminal and the internal power supply line.

8. The circuit according to claim 7, wherein
the first ESD protection diode is formed as a parasitic diode of the switch transistor.

9. The circuit according to claim 1, wherein
the resistor of the RC circuit has a first end connected to the first power terminal and a second end connected to the common node and the capacitor of the RC circuit has a first end connected to the common node and a second end connected to the second power terminal.

10. The circuit according to claim 9, wherein
the drive circuit includes three inverter circuits connected in series, the last inverter circuit connected in series producing an output signal that is the trigger signal supplied to the control electrode of the shunt transistor.

11. The circuit according to claim 1, wherein
the capacitor of the RC circuit has a first end connected to the first power terminal and a second end connected to the common node and the resistor of the RC circuit has a first end connected to the common node and a second end connected to the second power terminal.

12. The circuit according to claim 11, wherein
the drive circuit includes first and second inverter circuits, the second inverter circuit producing an output signal that is the trigger signal supplied to the control electrode of the shunt transistor.

13. An ESD protection circuit in a semiconductor device including a first power terminal to which an external power voltage is to be applied, a second power terminal to which a ground potential is to be applied, an internal power supply line, a switch transistor having a main current channel connected between the first power terminal and the internal power supply line, and an internal load circuit biased by a voltage of the internal power supply line, the ESD protection circuit comprising:
a shunt transistor having a main current channel connected between the second power terminal and the internal power supply line; and
an RC circuit, connected between the first power terminal and the second power terminal, which outputs a signal for controlling conductivity of the shunt transistor.

14. The circuit according to claim 13, further comprising:
a drive circuit including at least one stage of inverter, which supplies a trigger signal to a control electrode of the shunt transistor in response to an output signal of the RC circuit.

15. The circuit according to claim 14, wherein
the resistor of the RC circuit has a first end connected to the first power terminal and a second end connected to an input of the drive circuit and the capacitor of the RC circuit has a first end connected to the input of the drive circuit and a second end connected to the second power terminal.

16. The circuit according to claim 15, wherein
the drive circuit includes three inverter circuits connected in series, the last inverter circuit connected in series producing an output signal that is the trigger signal supplied to the control electrode of the shunt transistor.

17. The circuit according to claim 14, wherein
the capacitor of the RC circuit has a first end connected to the first power terminal and a second end connected to an input of the drive circuit and the resistor of the RC circuit has a first end connected to the input of the drive circuit and a second end connected to the second power terminal.

18. The circuit according to claim 17, wherein
the drive circuit includes the first and second inverter circuits connected in series, the second inverter circuit producing an output signal that is the trigger signal supplied to the control electrode of the shunt transistor.

19. A method of driving a shunt transistor of an ESD protection circuit having a first power terminal to which an external power voltage is to be applied, a second power terminal to which a ground potential is to be applied, an internal power supply line, and an RC circuit including a resistor and a capacitor connected in series between the first power terminal and the second power terminal, wherein the shunt transistor includes a main current channel connected between the second power terminal and the internal power supply line, said method comprising:
supplying an input signal into an inverter from a common node between the resistor of the RC circuit and the capacitor of the RC circuit; and
generating a trigger signal that is supplied to a control electrode of the shunt transistor from the output signal of the inverter.

20. The method according to claim 19, further comprising:
generating a control signal based on a comparison of a feedback voltage of the internal power supply line and a predetermined reference voltage; and
supplying the control signal to a control electrode of a switch transistor that is connected between the first power terminal and the internal power supply line.
